(19) United States
(12) Patent Application Publication
(10) Pub. No.: US 2026/0339028 A1
(43) Pub. Date: Oct. 29, 2026

(54) OPTICAL CIRCUIT

(71) Applicant: NICHIA CORPORATION, Anan-shi (JP)

(72) Inventor: Koichiro HATAKEYAMA, Yokohama-shi (JP)

(73) Assignee: NICHIA CORPORATION, Anan-shi (JP)

(21) Appl. No.: 19/659,281

(22) Filed: Apr. 27, 2026

(30) Foreign Application Priority Data
Apr. 28, 2025 (JP) 2025-074910

(51) Int. Cl. G02B 6/26

(52) U.S. Cl. CPC G02B 6/262

(57) ABSTRACT

An optical waveguide includes: a support substrate; and first, second and third optical waveguides located on the support substrate, each including a lower clad layer disposed on the support substrate, an upper clad layer, and a core layer interposed between the lower clad layer and the upper clad layer. The first optical waveguide is an active waveguide configured to emit light with a wavelength shorter than a wavelength of infrared light. The third optical waveguide is interposed between the first optical waveguide and the second optical waveguide. The third optical waveguide is butt-joined to at least one of the first optical waveguide or the second optical waveguide. The third optical waveguide is an amorphous waveguide.

### CROSS-REFERENCE TO RELATED APPLICATION

This application claims priority to Japanese Patent Application No. 2025-074910, filed on Apr. 28, 2025, the disclosure of which is hereby incorporated by reference in its entirety.

### TECHNICAL FIELD

The present disclosure relates to an optical circuit.

### BACKGROUND

As a technique to configure an optical circuit, an example of butt-joining a certain optical waveguide and another optical waveguide has been known (see, for example, PCT Publication No. WO2013/033252). PCT Publication No. WO2013/033252 discloses a III-V waveguide, an SOI waveguide, and a connection waveguide that connects the III-V and SOI waveguides. PCT Publication No. WO2013/033252 discloses an example in which the core of the connection waveguide is amorphous silicon and the clad is SiO₂. This is an optical circuit for waveguiding light in a wavelength range guidable by silicon, i.e., infrared light.

### SUMMARY

The scattering loss of waveguided light at the interface between a core layer and a clad layer is larger for shorter wavelengths. In an optical waveguide for light with wavelengths shorter than those of infrared light, scattering losses cannot be ignored. Thus, there is a need to reduce scattering losses.

An object of an embodiment of the present disclosure is to provide an optical circuit with reduced scattering losses.

According to one embodiment, an optical circuit includes: a support substrate, and a first optical waveguide, a second optical waveguide, and a third optical waveguide disposed on the support substrate, the first optical waveguide including a first substrate, a first lower clad layer disposed on the first substrate, a first upper clad layer, and a first core layer interposed between the first lower clad layer and the first upper clad layer, the second optical waveguide including a second substrate formed of a different material from that for the first substrate, a second lower clad layer, a second upper clad layer, and a second core interposed between the second lower clad layer and the second upper clad layer, and the third optical waveguide including a third lower clad layer, a third upper clad layer, and a third core layer interposed between the third lower clad layer and the third upper clad layer. The first optical waveguide is an active waveguide capable of emitting light with wavelengths shorter than those of infrared light. The third optical waveguide is disposed between the first optical waveguide and the second optical waveguide. The third optical waveguide is butt-joined to at least one of the first optical waveguide and the second optical waveguide. The third optical waveguide is an amorphous waveguide. The third optical waveguide satisfies at least one of: (i) the arithmetic mean roughness (Ra) of the interface between the third core layer and the third upper clad layer is larger than the arithmetic mean roughness (Ra) of the interface between the second core layer and the second upper clad layer, and the refractive index difference between the third core layer and the third upper clad layer is smaller than the refractive index difference between the second core layer and the second upper clad layer, or (ii) the arithmetic mean roughness (Ra) of the interface between the third core layer and the third lower clad layer is larger than the arithmetic mean roughness (Ra) of the interface between the second core layer and the second lower clad layer, and the refractive index difference between the third core layer and the third lower clad layer is smaller than the refractive index difference between the second core layer and the second lower clad layer.

According to the present disclosure, an optical circuit capable of reducing scattering losses can be provided.

### BRIEF DESCRIPTION OF THE DRAWINGS

FIG. 1 is a schematic top view of an optical circuit of Embodiment 1.

FIG. 2 is a cross-sectional view taken along line II-II in FIG. 1.

FIG. 3 is a cross-sectional view taken along line III-III in FIG. 1.

FIG. 4 is a cross-sectional view taken along line IV-IV in FIG. 1.

FIG. 5 is a cross-sectional view taken along line V-V in FIG. 1.

FIG. 6 is a cross-sectional view showing an example of manufacturing method.

FIG. 7 is a cross-sectional view showing the example of manufacturing method.

FIG. 8 is a top view showing the example of manufacturing method.

FIG. 9 is a cross-sectional view showing an example of manufacturing method.

FIG. 10 is a cross-sectional view showing the example of manufacturing method.

FIG. 11 is a top view of an optical circuit of Variation 1.

FIG. 12 is a cross-sectional view of an optical circuit of Variation 2.

FIG. 13 is a cross-sectional view of an optical circuit of Variation 3.

FIG. 14 is a cross-sectional view of an optical circuit of Embodiment 2.

FIG. 15 is a top view of an optical circuit of Variation 4.

FIG. 16 is a top view of an optical circuit of Embodiment 3.

FIG. 17 is a cross-sectional view taken along line XVII-XVII in FIG. 16.

### DETAILED DESCRIPTION

In the present specification, the term, “process,” includes not only an independent process, but also one that achieves the intended objective thereof even if not clearly distinguished from another process. Certain embodiments of the present invention will be described in detail below. However, the embodiments described below are examples of optical circuits and manufacturing methods thereof provided to give shape to the technical ideas of the present invention. The present invention is not limited to the optical circuits and the manufacturing methods described below.

### Embodiment 1

### Optical Circuit 1000

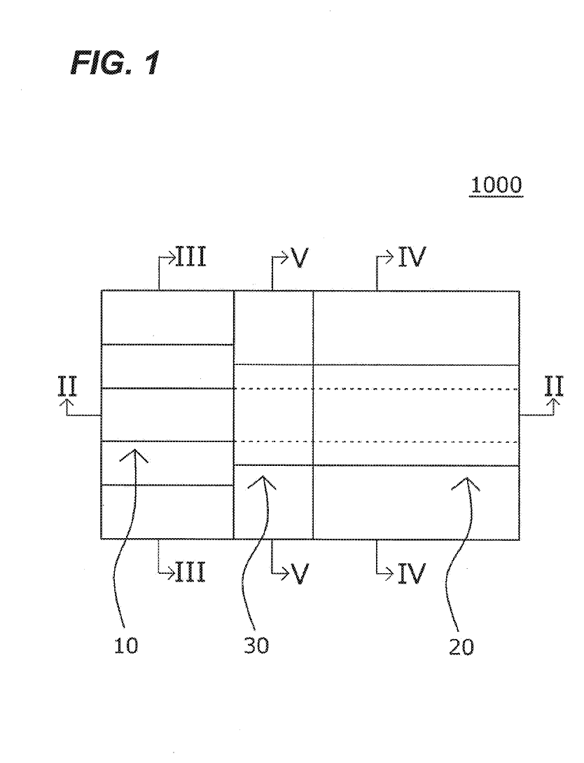

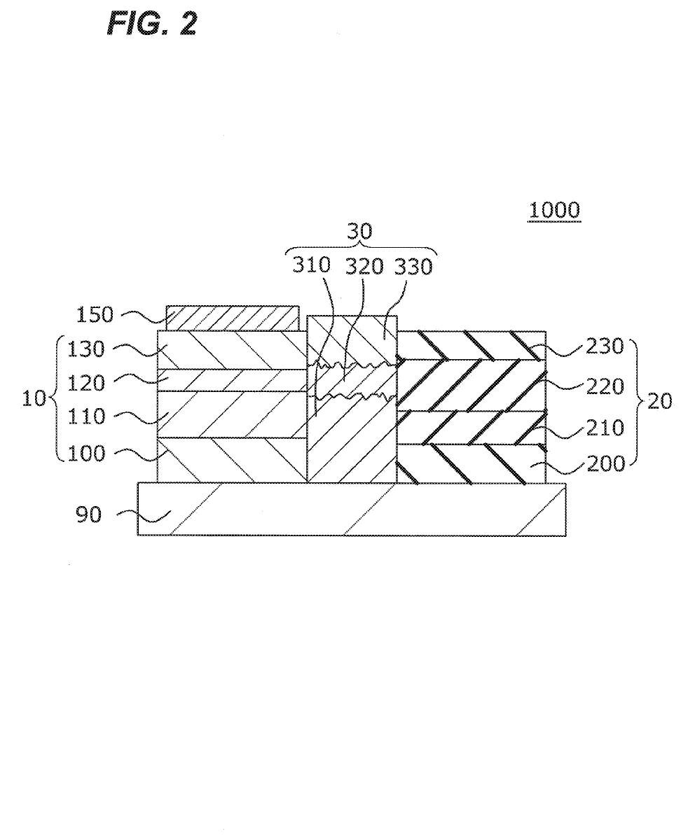

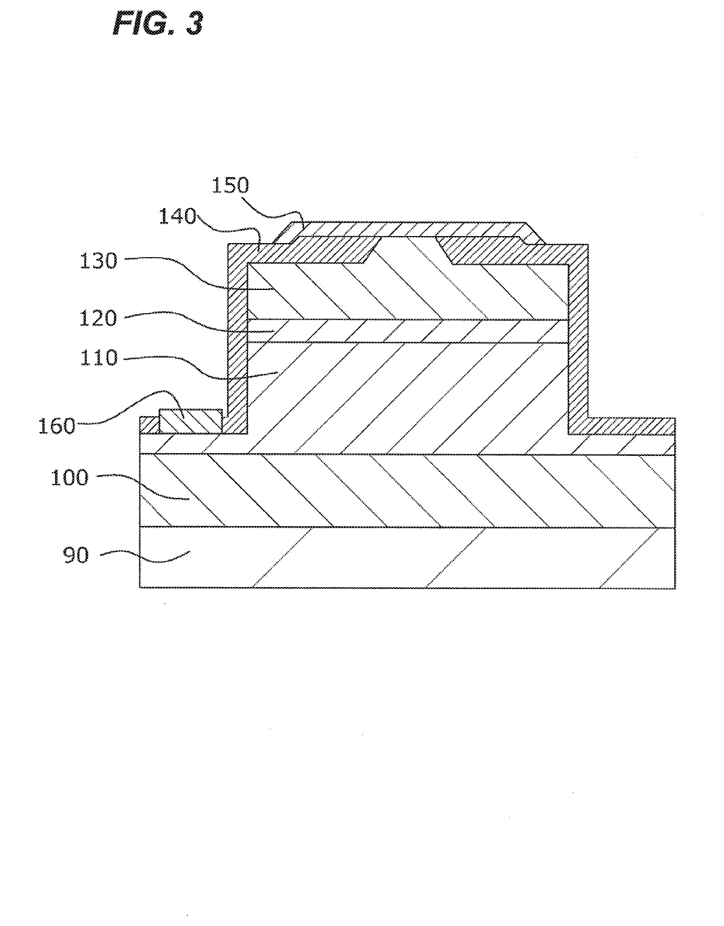

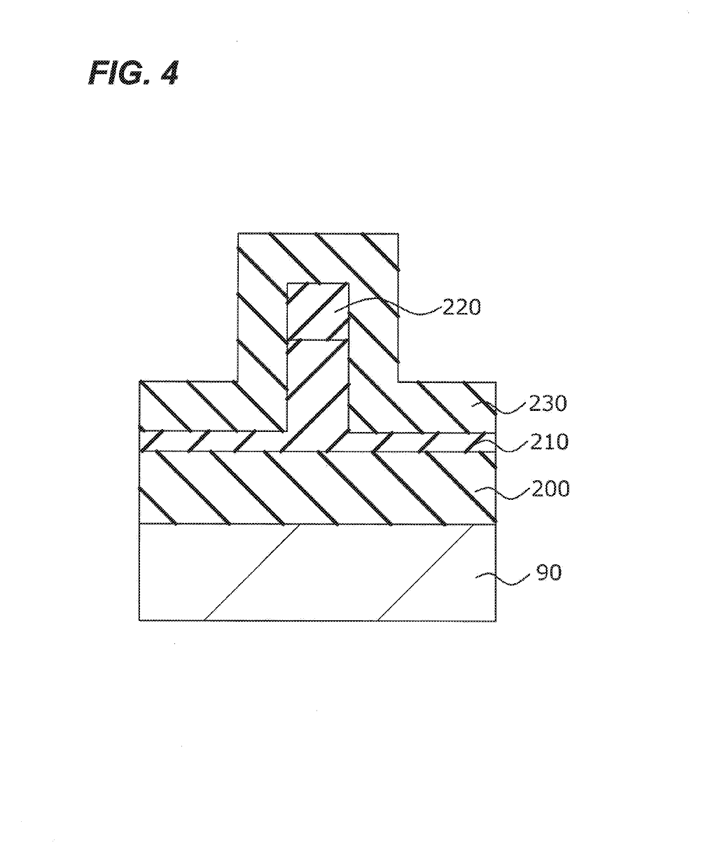

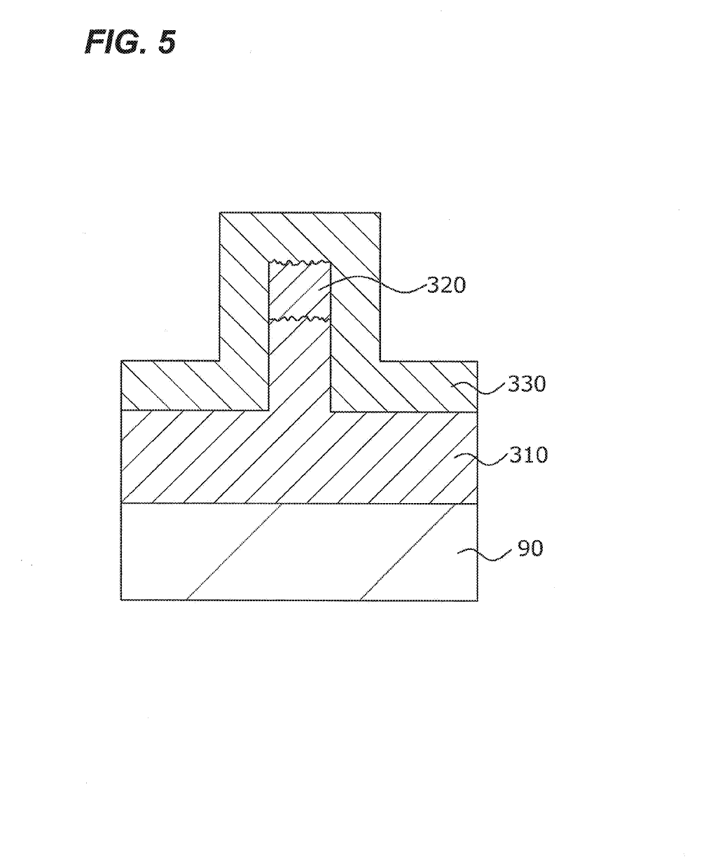

An optical circuit 1000 of Embodiment 1 will be explained with reference to FIG. 1 to FIG. 5. FIG. 1 s a top view of an optical waveguide according to Embodiment 1. FIG. 2 is a cross-sectional view taken along line II-II in FIG. 1. FIG. 3 is a cross-sectional view taken along line III-III in FIG. 1. FIG. 4 is a cross-sectional view taken along line IV-IV in FIG. 1. FIG. 5 is a cross-sectional view taken along line V-V in FIG. 1.

Primary constituents of the present disclosure will be explained first. As shown in FIG. 1 and FIG. 2, the optical circuit 1000 according to Embodiment 1 includes a support substrate 90, a first optical waveguide 10, a second optical waveguide 20, and a third optical waveguide 30. The third optical waveguide 30 is butt-joined to at least one of the first optical waveguide 10 and the second optical waveguide 20. The first optical waveguide 10 is an active waveguide, and emits light with wavelengths shorter than those of infrared light. The third optical waveguide 30 is an amorphous waveguide satisfying following (i) and/or (ii): (i) the surface roughness of the interface between the third core layer 320 and the third upper clad layer 330 of the third optical waveguide 30 is larger than the surface roughness of the interface between the second core layer 220 and the second upper clad layer 230 of the second optical waveguide 20, and the refractive index difference between the third core layer 320 and the third upper clad layer 330 of the third optical waveguide 30 is smaller than the refractive index difference between the second core layer 220 and the second upper clad layer 230 of the second optical waveguide 20, and/or (ii) the surface roughness of the interface between the third core layer 320 and the third lower clad layer 310 of the third optical waveguide 30 is larger than the surface roughness of the interface between the second core layer 220 and the second lower clad layer 210 of the second optical waveguide 20, and the refractive index difference between the third core layer 320 and the third lower clad layer 310 of the third optical waveguide 30 is smaller than the refractive index difference between the second core layer 220 and the second lower clad layer 210 of the second optical waveguide 20. The optical circuit 1000 has at least one of the configurations (i) and (ii).

When an optical waveguide causes scattering loss attributed to surface roughness of the interface, the scattering loss is known to be proportional to wavenumber k₀ ³ according to Lacey & Payne, IEE Proceedings, Part J, Optoelectronics 137, 282 (1990). In other words, scattering loss decreases in inverse proportion to a wavelength cubed. This means that the shorter the wavelength the larger the scattering loss tends to be. For example, comparing the scattering loss at communication waveband of 1550 nm and visible light wavelength of 500 nm, the scattering loss at 500 nm is about 30 times larger based on 1/(500/1550)³. Therefore, the shorter the wavelength, the larger the scattering loss attributed to the surface roughness of the interface between the core layer and the clad layer becomes.

Furthermore, when the refractive index of a core layer is n_{core} and the refractive index of a clad layer is n_{clad}, the scattering loss is proportional to (n_{core} ²-n_{clad} ²)². It is understood that the smaller the refractive index difference between the core layer and the clad layer, the more reduction in scattering loss results. Furthermore, because (n_{core} ²-n_{clad} ²)² equals (n_{core}+n_{clad})² (n_{core}-n_{clad})², scattering loss is reduced by the square of the refractive index difference between the core layer and the clad layer. For example, setting the refractive index difference on the order of 1×10⁻¹ or 1×10⁻² for the visible light waveband waveguide, as compared to the refractive index difference on the order of 1×10⁰ for the communication waveband waveguide, can reduce the scattering loss to about 1/100 to 1/10000. This means the reduced refractive index difference between the core layer and the clad layer can compensate for the larger scattering loss for visible light than the communication waveband as described above. Accordingly, even in the case of including an optical waveguide that has a large arithmetic mean roughness Ra at the interface between the core layer and the clad layer, the scattering loss of the optical circuit 1000 of Embodiment 1 that waveguides light with wavelengths shorter than those of infrared light can be reduced as long as at least one of the (i) or (ii) described below is satisfied. Preferably, satisfying both (i) and (ii) can further reduce scattering loss. The (i) and (ii) are: (i) the refractive index difference between the third core layer 320 and the third upper clad layer 330 of the third optical waveguide 30 is smaller than the refractive index difference between the second core layer 220 and the second upper clad layer 230 of the second optical waveguide 20, and (ii) the refractive index difference between the third core layer 320 and the third lower clad layer 310 of the third optical waveguide 30 is smaller than the refractive index difference between the second core layer 220 and the second lower clad layer 210 of the second optical waveguide 20.

The coupling efficiency of the third optical waveguide 30 and the first optical waveguide 10, and the coupling efficiency of the third optical waveguide 30 and the second optical waveguide 20 is, for example, 50% or higher and lower than 100%, 75% or higher and lower than 100%, or 90% or higher and lower than 100%. In FIG. 1, the widths of the second core layer 220 of the second optical waveguide 20 and the third core layer 320 of the third optical waveguide 30 are shown using broken lines. As shown in FIG. 1, in a top view, the lateral core width of the first optical waveguide 10, the lateral core width of the second optical waveguide 20, and the lateral core width of the third optical waveguide 30 are preferably substantially the same. This facilitates the alignment of the lateral optical axes. The optical axes of coupled optical waveguides are tolerated for angular misalignment or axial misalignment in the lateral or thickness direction within ranges that allow for optical coupling. The angular misalignment of the optical axes may be 10° at most, preferably 1° at most, more preferably 0.5° at most. The axial misalignment in the lateral direction may be 50% at most, preferably 10% at most, more preferably 1% at most of the smaller lateral core width of two coupled optical waveguides. The axial misalignment in the stacking direction may be 50% at most, preferably 10% at most, more preferably 1% at most of the smaller core width in the stacking direction of two coupled optical waveguides.

### First Optical Waveguide 10

A first optical waveguide 10 is an active waveguide capable of emitting light with wavelengths shorter than those of infrared light. The first optical waveguide 10 is an active waveguide that emits visible or ultraviolet light. The first optical waveguide 10 is, for example, a semiconductor laser element. In the present specification, light having a peak wavelength of 780 nm or longer is referred to as infrared light and distinguished from visible and ultraviolet light. The first optical waveguide 10, when excited by an electric current, emits visible light having a peak wavelength in a range of 360 nm to 700 nm, preferably 400 nm to 560 nm, or ultraviolet light having a peak wavelength of 360 nm or longer and shorter than 400 nm.

The first optical waveguide 10 includes a first substrate 100, a first lower clad layer 110, a first upper clad layer 130, and a first core layer 120 interposed between the first lower clad layer 110 and the first upper clad layer 130. The first core layer 120 includes an active layer. The first core layer 120 may include a first light guide layer between the active layer and the first lower clad layer 110, and a second light guide layer between the active layer and the first upper clad layer 130.

The first substrate 100 may be, for example, a gallium nitride substrate, a gallium arsenide substrate, or a sapphire substrate. The first lower clad layer 110 and the first upper clad layer 130 may be, for example, a nitride semiconductor, an arsenide semiconductor, or phosphide semiconductor. The first lower clad layer 110 and the first upper clad layer 130 are preferably nitride semiconductors, and include AlₓIn_{y}Ga_{1-(x+y)}N (0≤x≤1, 0≤y≤1, 0≤x+y≤1). The first core layer 120 includes a quantum well layer including a well layer and a barrier layer. The quantum well layer may be a single or multiple quantum well layer. The well layer may be, for example, In_{z}Ga_{1-z}N (0≤z≤1) or AlₐGa₁₋ₐN (0<a<1). This allows the quantum well layer to emit red to ultraviolet light by adjusting the composition of the well layer. The red light may be achieved by using AlGaInP mixed crystal. Even in this case, the wavelength within the red range can be selected by adjusting the composition.

As shown in FIG. 3, the first optical waveguide 10 has a ridge in the first upper clad layer 130, confining light in the lateral direction as well. The first optical waveguide 10 may be a multimode waveguide or a single-mode waveguide, preferably a single-mode waveguide. This can facilitate stable operation of an optical waveguide having an optical function provided downstream. For example, this can facilitate the stable operation of the wavelength selecting structure provided in the second optical waveguide 20 in Embodiment 2 described later. A first electrode 150 is disposed on the upper face of the ridge. A second electrode 160 is disposed on the first lower clad layer 110. The lateral faces of the first upper clad layer 130, the first core layer 120, and the first lower clad layer 110 are protected by an insulation layer 140. This can reduce leaks.

### Second Optical Waveguide 20

A second optical waveguide 20 may be an optical wire for coupling the light emitted by the first optical waveguide 10 to an optical waveguide having another optical function or outputting the light from the optical circuit 1000. The second optical waveguide 20 is an optical waveguide with reduced losses as described below.

As shown in FIG. 4, the second optical waveguide 20 has a second substrate 200, a second lower clad layer 210, a second upper clad layer 230, and a second core layer 220 interposed between the second lower clad layer 210 and the second upper clad layer 230. The second optical waveguide 20 is such that the bottom face of the ridge is positioned in the second lower clad layer 210. This can enhance the light confinement in the lateral direction, thereby reducing bend losses of the optical waveguide. This will be described later. The second optical waveguide 20 has a lateral clad layer on the lateral faces of the second core layer 220. This can allow the second optical waveguide 20 to achieve a desired spot diameter while confining light in the lateral direction. The lateral clad layer may be formed of the same material as that for the second upper clad layer 230. The lateral clad layer and the second upper clad layer 230 may be a monolithic clad layer.

The second substrate 200 may be, for example, a Si substrate, a CaF₂ substrate, a GaN substrate, or a sapphire substrate. In the case in which the second optical waveguide 20 functions as an optical wire, the second optical waveguide 20 tends to have large dimensions in vertical and horizontal directions in order to have the optical wire distance, as compared to the first optical waveguide 10 and the third optical waveguide 30. Accordingly, a relatively inexpensive substrate such as a Si, or sapphire substrate, is preferable.

The second optical waveguide 20 includes an oxide, nitride, fluoride, or oxynitride. The second optical waveguide 20 is preferably an oxide or oxynitride. This can configure the optical waveguide with a material with relatively small light absorption. The second lower clad layer 210 and the second upper clad layer 230 may be SiO₂, Al₂O₃, MgF₂, CaF₂, or a material combining these. The second lower clad layer 210 and the second upper clad layer 230 are preferably formed of the same material. This can make the refractive index difference uniform in the thickness direction, thereby facilitating the confinement of light in the second core layer 220. The second core layer 220 transmits light with wavelengths shorter than those of infrared light. The second core layer 220 may be, for example, Ta₂O₅, Nb₂O₅, TiO₂, HfO₂, LiNbO₃, AlN, SiN, SiON, or a material combining these. The refractive index difference between the second upper clad layer 230 and the second core layer 220 may be, for example, 0.05 to 1.0, preferably 0.1 to 0.5.

The combination of the materials for the second core layer 220 and the second upper clad layer 230 may be, for example, SiON and SiO₂, SiN and SiO₂, SiN and SiON, or Ta₂O₅ and Al₂O₃. It is selected based on the combination of the materials for the second core layer 220 and the second lower clad layer 210.

The surface roughness of the interface Ra between the second upper clad layer 230 and the second core layer 220 can be, for example, 0.1 nm to 1 nm, preferably 0.1 nm to 0.3 nm. As described later, the optical circuit 1000 of Embodiment 1 is such that the first optical waveguide 10 and the second optical waveguide 20 can be separately produced before being butt-joined. In such a case, each optical waveguide can be heat processed at the temperature or for the duration required for facilitating crystal growth and planarization. This can planarize the interface between the second upper clad layer 230 and the second core layer 220 of the second optical waveguide 20. This can thus reduce the scattering loss attributed to the surface roughness of the interface. Similarly, the surface roughness of the interface Ra between the second lower clad layer 210 and the second core layer 220 can be, for example, 0.1 nm to 1 nm, preferably 0.1 nm to 0.3 nm. This can planarize the interface between the second lower clad layer 210 and the second core layer 220, thereby reducing the scattering loss attributed to the surface roughness of the interface.

### Third Optical Waveguide 30

A third optical waveguide 30 connects the first optical waveguide 10 and the second optical waveguide 20. The third optical waveguide 30 is an amorphous waveguide. The third optical waveguide 30 is butt-joined to at least one of the first optical waveguide 10 and the second optical waveguide 20. The third optical waveguide 30 is preferably butt-joined to both the first optical waveguide 10 and the second optical waveguide 20. This can efficiently optically couple the third optical waveguide 30 to the first optical waveguide 10 and the second optical waveguide 20.

As shown in FIG. 5, the third optical waveguide 30 includes on the support substrate 90 a third lower clad layer 310, a third upper clad layer 330, and a third core layer 320 between the third lower clad layer 310 and the third upper clad layer 330. The third optical waveguide 30 is such that the bottom face of the ridge is positioned in the third lower clad layer 310. The third optical waveguide 30 further includes a lateral clad layer on the lateral faces of the third core layer 320 as well. This can approximate the cross-sectional shape of the third optical waveguide 30 in the direction perpendicular to the optical axis of the optical waveguide to that of the second optical waveguide 20, thereby increasing the coupling efficiency to the second optical waveguide 20. The lateral clad layer may be formed of the same material as that for the third upper clad layer 330. The lateral clad layer and the third upper clad layer 330 may be a monolithic clad layer.

The refractive index difference between the third core layer 320 and the third upper clad layer 330 is 1 at most. The reduced refractive index difference reduces scattering losses. However, the refractive index of the third core layer 320 is larger than the refractive index of the third upper clad layer 330. The refractive index difference between the third core layer 320 and the third upper clad layer 330 may be, for example, 0.5 at most, preferably 0.1 at most, more preferably 0.05 at most. The smaller the refractive index difference, the smaller the scattering loss results. The refractive index difference between the third core layer 320 and the third lower clad layer 310 does not necessarily have to be the same as the refractive index difference between the third core layer 320 and the third upper clad layer 330, but is set, for example, to 1 at most, 0.5 at most, 0.1 at most, or 0.05 at most.

The third optical waveguide 30 is an amorphous waveguide, and includes an oxide, nitride, fluoride, or oxynitride. The third optical waveguide 30 is preferably an oxide or oxynitride. This can configure the optical waveguide with a relatively less light absorbing material. The third lower clad layer 310 and the third upper clad layer 330 may be, for example, SiO₂, Al₂O₃, MgF₂, CaF₂, or a material combining these. The third lower clad layer 310 and the third upper clad layer 330 are preferably formed of the same material. This can make the refractive index difference uniform in the thickness direction, making it easier to confine light in the third core layer 320. The third core layer 320 may be Ta₂O₅, Nb₂O₅, TiO₂, HfO₂, AlN, SiN, SiON, or a material combining these.

The combination of the materials for the third core layer 320 and the third upper clad layer 330 may be, for example, SiON and SiO₂, SiN and SiO₂, SiN and SiON, or Ta₂O₅ and Al₂O₃. However, the refractive index difference between the third core layer 320 and the third upper clad layer 330 satisfies the relationship described above. The combination of the materials for the third core layer 320 and the third lower clad layer 310 is selected from the same or similar combinations.

The arithmetic mean roughness Ra of the interface between the third core layer 320 and the third upper clad layer 330 can be, for example, 0.5 nm to 5 nm, preferably 1 nm to 3 nm. Similarly, the surface roughness of the interface between the third core layer 320 and the third lower clad layer 310 can be, for example, 0.5 nm to 5 nm, preferably 1 nm to 3 nm.

Individual constituent elements have been explained thus far. The interrelations of the constituents will be described below. Materials applied to the layers can be suitably changed to make the refractive index difference between the third core layer 320 and the third upper clad layer 330 different from the refractive index difference between the second core layer 220 and the second upper clad layer 230. For example, (a) the material for the third core layer 320 may be different from that for the second core layer 220 in terms of material system or composition, (b) the material for the third upper clad layer 330 may be different from that for the second upper clad layer 230 in terms of material system or composition, and (c) the material for the third lower clad layer 310 may be different from that for the second lower clad layer 210 in terms of material system or composition. It is sufficient to satisfy only one of the (a), (b), and (c) above.

Being “different in terms of material system” refers to a material having a different basic structure, such as SiN versus Ta₂O₅. Being “different in terms of composition” refers to a material in which a portion of the basic structure is replaced with a different element, such as SiON. A different material system results in a different refractive index. Refractive indices may be ascertained from published values. If a composition changes, the refractive index change in accordance with the composition. For example, the refractive index of SiON which is between SiN and SiO₂ would be a value that is between the refractive index of the SiN and the refractive index of SiO₂. A refractive index value monotonously increases as the proportion of N changes. If the compositional ratio is known, the magnitude relation of refractive indices will be found. The material system and the compositional ratio can be analyzed by TEM (transmission electron microscopy) and EDX (energy-dispersive X-ray spectrometry) performed on a cross section.

When the third upper clad layer 330 and the second upper clad layer 230 are formed of the same material, the refractive index of the third core layer 320 is smaller than the refractive index of the first core layer 120, and is equal to or smaller than the refractive index of the second core layer 220.

When the third core layer 320 and the second core layer 220 are formed of the same material, the refractive index of the third upper clad layer 330 is smaller than the refractive index of the first upper clad layer 130, and is equal to or larger than the refractive index of the second upper clad layer 230. This can reduce Fresnel reflection. Similarly, the refractive index of the third lower clad layer 310 is smaller than the refractive index of the first lower clad layer 110, and is equal to or larger than the refractive index of the second lower clad layer 210.

The thickness of the third core layer 320 may be larger than the thickness of the first core layer 120, and smaller than the thickness of the second core layer 220. The refractive index difference between the third core layer 320 and the third upper clad layer 330 of the third optical waveguide 30 is smaller than the refractive index difference between the second core layer 220 and the second upper clad layer 230 of the second optical waveguide 20. Accordingly, the light confinement of the third optical waveguide 30 is relatively weak. At this time, setting the thickness of the third core layer 320 to that between the thicknesses of the first core layer 120 and the second core layer 220 can reduce the differences among the spot diameters of light waveguided in the optical waveguides. This can improve the coupling efficiency of optical waveguides.

The length of the third optical waveguide 30 in the optical axis direction is smaller than the length of the second substrate 200 in the optical axis direction of the third optical waveguide 30. This can shorten the third optical waveguide 30, and can reduce scattering losses. The third optical waveguide 30 preferably has a relatively small length because the arithmetic mean roughness Ra of the interface between the third core layer 320 and the third upper clad layer 330 is larger than the arithmetic mean roughness Ra of the interface between the second core layer 220 and the second upper clad layer 230 of the second optical waveguide 20. The length of the third optical waveguide 30 in the optical axis direction is at least 0.01 but less than 1 times the length of the second substrate 200 in the optical axis direction of the third optical waveguide 30, preferably 0.01 to 0.2 times. The length of the third optical waveguide 30 in the optical axis direction may be, for example, larger than 0 μm but 1000 μm at most, preferably larger than 0.1 μm but 500 μm at most, more preferably larger than 0.5 μm but 10 μm at most.

In the optical axis direction of the third optical waveguide 30, the third lower clad layer 310 is disposed between the first substrate 100 and the second substrate 200. The refractive index difference between the third core layer 320 and the third lower clad layer 310 of the third optical waveguide 30 is relatively small, and light confinement of the third optical waveguide 30 is weak. Even though light readily spreads to the support substrate 90 in the third optical waveguide 30, the third lower clad layer 310 being formed with a large thickness between the first substrate 100 and the second substrate 200 can efficiently confine light in the third core layer 320 thereby reducing light losses.

In this embodiment, an example in which the second optical waveguide 20 is an optical wire has been described, but the second optical waveguide 20 is not limited to an optical wire. The second optical waveguide 20 may be an optical waveguide that has another optical function.

### Manufacturing Method

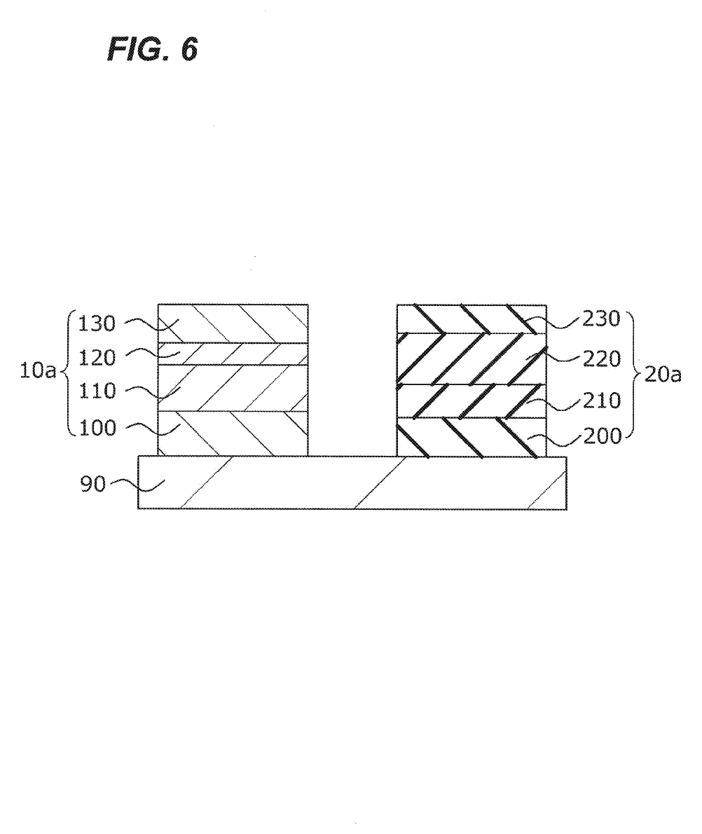

An example of method of manufacturing an optical circuit 1000 of Embodiment 1 will be described. FIGS. 6-8 are schematic views showing one example of method of manufacturing the optical circuit 1000 of Embodiment 1.

As shown in FIG. 6, a first stack 10a in which a first substrate 100, a first lower clad layer 110, a first core layer 120, and a first upper clad layer 130 are stacked and a second stack 20a in which a second substrate 200, a second lower clad layer 210, a second core layer 220, and a second upper clad layer 230 are stacked are disposed to oppose one another on a support substrate 90. Preferably, the first stack 10a and the second stack 20a are disposed such that at least the first core layer 120 and the second core layer 220 oppose one another. A gap of a predetermined width is provided between the first stack 10a and the second stack 20a. This is because an unintended gap might be created should the first stack 10a and the second stack 20a be brought into contact, as the opposing end faces are not necessarily parallel. Such a gap can reduce optical coupling efficiency. The width of the gap provided between the first stack 10a and the second stack 20a, i.e., the shortest distance between the first stack 10a and the second stack 20a, is 10 μm to 500 μm, for example.

The first stack 10a is formed by metal organic vapor deposition, for example. The second stack 20a is formed by chemical vapor deposition (CVD), sputtering, or vapor deposition, for example. The first stack 10a and the second stack 20aare individually formed and disposed on the support substrate 90. Accordingly, the first stack 10a and the second stack 20a can each be formed at a suitable temperature. The second stack 20a, in particular, can be prepared in advance so as to reduce the arithmetic mean surface roughness of the interface Ra between the second core layer 220 and the second lower clad layer 210, and between the second core layer 220 and the second upper clad layer 230.

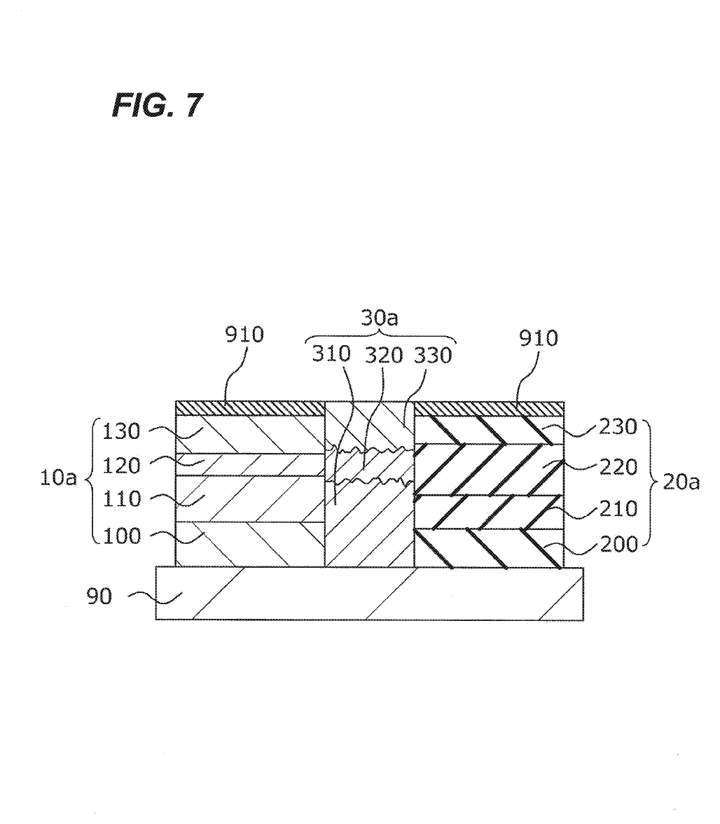

Then as shown in FIG. 7, a mask 910 is placed on the first stack 10a and the second stack 20a, and a third stack 30a is disposed in the gap between the first stack 10a and the second stack 20a. The third stack 30ahas, successively from the support substrate 90 side, a third lower clad layer 310, a third core layer 320, and a third upper clad layer 330. The third stack 30ais formed by CVD, sputtering, atomic layer deposition, or the like. Unlike the case of individually preparing the first stack 10a and the second stack 20a, restrictions apply to the forming temperature for the third stack 30a. Because the third stack 30ais disposed to fill the gap between the first stack 10a and the second stack 20a, thermal expansion coefficient differences with respect to these materials need to be taken into consideration. If the forming temperature for the third stack 30a is too high, the stress caused by the thermal coefficient differences would allow at least one of the first stack 10a and the second stack 20a to easily detach from the third stack 30a. In order to reduce the stress caused by a thermal expansion coefficient difference, the third stack 30a needs to be formed at a lower temperature than the temperature at which the second stack 20a is formed, for example. At this time, the arithmetic mean roughness Ra of the interfaces between the third core layer 320 and the lower clad layer 310 and between the third core layer 320 and the third upper clad layer 330 cannot be fully reduced, resulting in larger arithmetic mean roughness Ra than those of the corresponding interfaces of the second optical waveguide 20.

Even in such a case, scattering losses can be reduced by forming the third stack 30a such that the refractive index difference between the third core layer 320 and the third upper clad layer 330 is smaller than the refractive index difference between the second core layer 220 and the second upper clad layer 230. Scattering losses can be reduced by forming the third stack 30a such that the refractive index difference between the third core layer 320 and the third lower clad layer 310 is smaller than the refractive index difference between the second core layer 220 and the second lower clad layer 210.

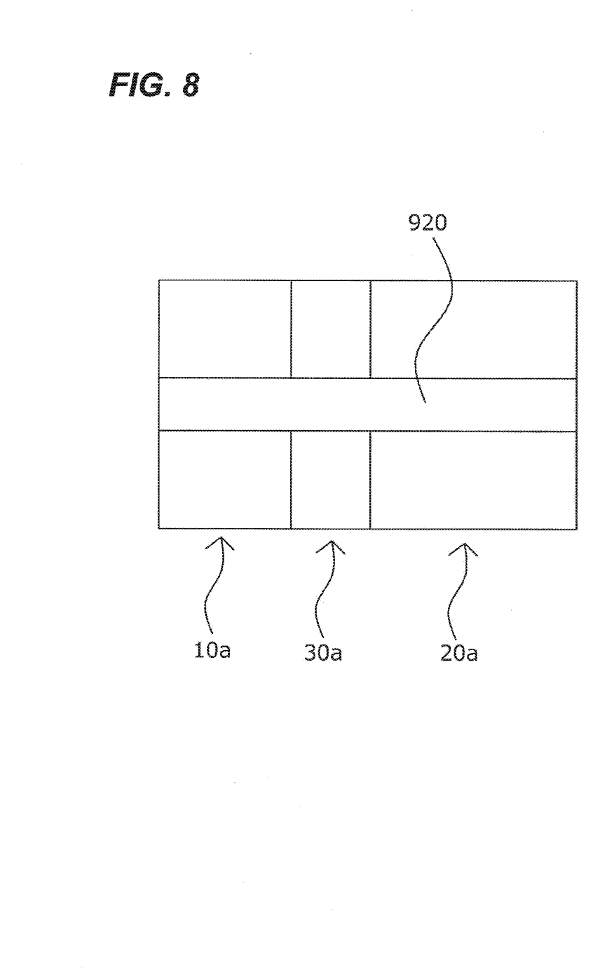

Then as shown in FIG. 8., a mask 920 having a pattern collectively corresponding to the regions where ridges will be formed is placed on the first stack 10a, the third stack 30a, and the second stack 20a. Each stack is etched based on the mask 920. Then a lateral clad layer is formed to cover the exposed lateral faces of the second stack 20a and the third stack 30a. This forms the first optical waveguide 10, the second optical waveguide 20a, and the third optical waveguide 30 shown in FIG. 1. The first optical waveguide 10 is further etched suitably for disposing an electrode.

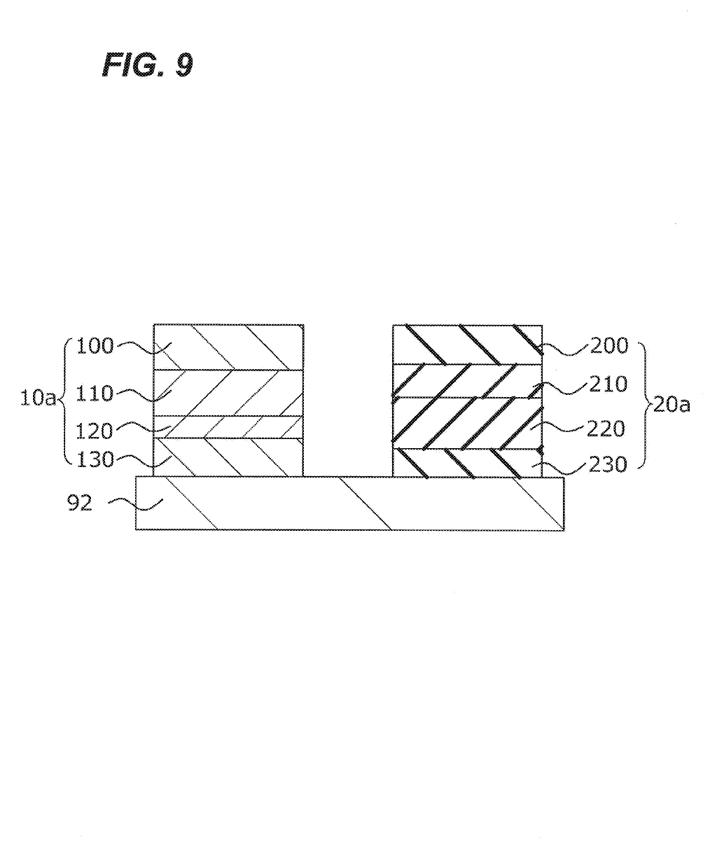

FIG. 9 is a schematic view of another example of method of manufacturing an optical waveguide of Embodiment 1. In this example, the first stack 10a and the second stack 20a are not disposed directly on the support substrate 90, but fixed to a provisional substrate 92. The upper face of the first upper clad layer 130 of the first stack 10a and the upper face of the second upper clad layer 230 of the second stack 20a are bonded to a principal face of the provisional substrate 92.

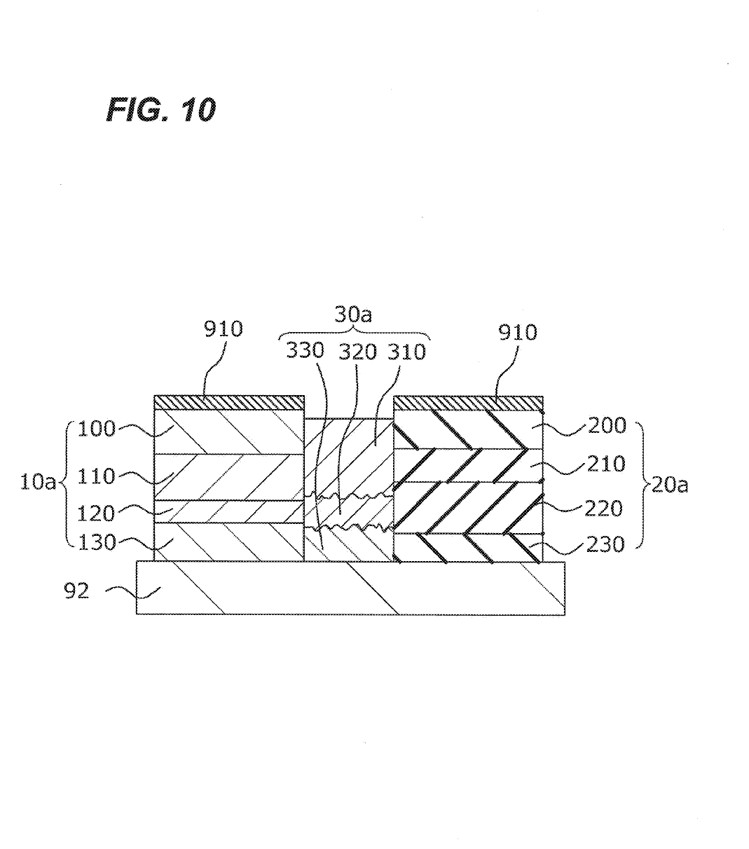

Then as shown in FIG. 10, a mask 910 is placed on the first stack 10a and the second stack 20a, and a third upper clad layer 330, a third core layer 320, and a third lower clad layer 310 are formed in that order on the provisional substrate 92. Because of the restrictions similarly applied to the forming temperature for the third stack 30a in this case, it is difficult to reduce the arithmetic mean roughness of the interfaces between the third core layer 320 and the third upper clad layer 330 and between the third clad layer and the third lower clad layer 310. However, scattering losses can be reduced by forming the third stack 30a such that the refractive index difference between the third core layer 320 and the third upper clad layer 330 is smaller than the refractive index difference between the second core layer 220 and the second upper clad layer 230. Scattering losses can be reduced by forming the third stack 30a such that the refractive index difference between the third core layer 320 and the third lower clad layer 310 is smaller than the refractive index difference between the second core layer 220 and the second lower clad layer 210.

Then the first substrate 100, the third lower clad layer 310, and the second substrate 200 are polished to align the heights, and transferred to a support substrate 90. Then as shown in FIG. 8, a mask 920 having a pattern collectively corresponding to the regions where ridges will be formed is placed on the first stack 10a, the third stack 30a, and the second stack 20a. Each stack is etched based on the mask 920. Then a lateral clad layer is formed to cover the exposed lateral faces of the second stack 20a and the third stack 30a. This forms the first optical waveguide 10, the second optical waveguide 20a, and the third optical waveguide 30 shown in FIG. 1.

### Variation 1

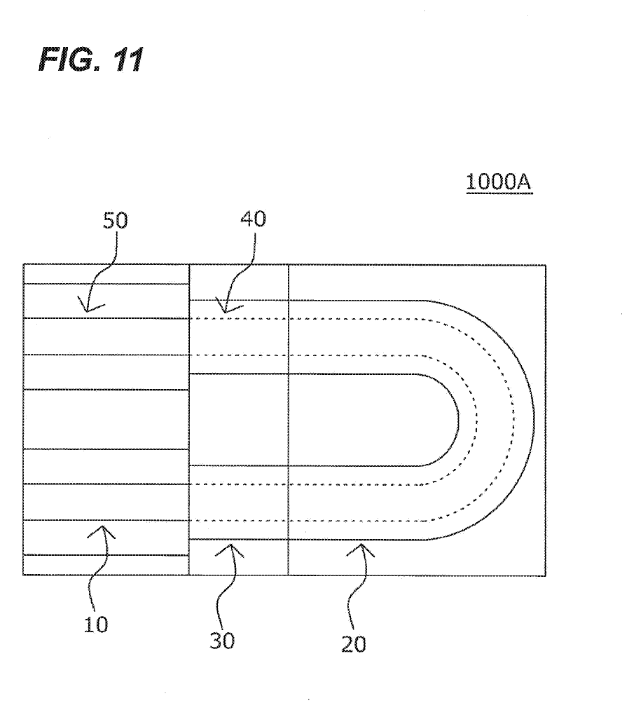

FIG. 11 is a top view of an optical circuit 1000A of Variation 1. The optical circuit 1000A of Variation 1 differs from the optical circuit 1000 of Embodiment 1 at least on the following point. The second optical waveguide 20 includes a bent waveguide. An optical circuit 1000A with reduced bending losses in the second optical waveguide 20 can be obtained. The optical circuit 1000A of Variation 1 may further include a fourth optical waveguide 40 and a fifth optical waveguide 50. In FIG. 11, broken lines indicate the widths of the second core layer 220 of the second optical waveguide 20, the third core layer 320 of the third optical waveguide 30, and the fourth core layer 420 of the fourth optical waveguide 40.

As described above, the second optical waveguide 20 is such that the bottom face of the ridge is positioned in the second lower clad layer 210 in a cross section perpendicular to the optical axis. This can enhance lateral light confinement, thereby reducing bending losses of the optical waveguide. Accordingly, the size of the optical circuit 1000A can be reduced in the waveguiding direction by making the bending radius relatively small. This can save space for the optical wire in the case in which the second optical waveguide functions as an optical wire, for example. Furthermore, using the same material for the lateral clad layer of the second optical waveguide 20 as that for the second upper clad layer 230 can achieve a desired spot diameter while enhancing lateral light confinement. The refractive index difference between the core layer and the lateral clad layer is smaller as compared to air being used for lateral light confinement. This can reduce the scattering losses attributed to the protrusions and depressions created on the lateral faces of the second optical waveguide 20 during the etching process.

The optical circuit 1000A of Variation 1 may further include a fourth optical waveguide 40 and a fifth optical waveguide 50. The fourth optical waveguide 40 is an amorphous waveguide, and is positioned between the second optical waveguide 20 and the fifth optical waveguide 50. The fourth optical waveguide 40 is butt-joined to at least one of the second optical waveguide 20 and the fifth waveguide 50. Similar to the third optical waveguide 30, the fourth optical waveguide 40 connects the second optical waveguide 20 and the fifth optical waveguide 50. Accordingly, the refractive index difference between the core layer and the upper clad layer of the fourth optical waveguide 40 is smaller than the refractive index difference between the second core layer 220 and the second upper clad layer 230 of the second optical waveguide 20, which reduces the scattering loss. Alternatively, the refractive index difference between the core layer and the lower clad layer of the fourth optical waveguide 40 is smaller than the refractive index difference between the core layer 220 and the second lower clad layer 210 of the second optical waveguide 20, which reduces the scattering loss. The fifth optical waveguide 50 is an active waveguide having a predetermined function, such as a semiconductor laser amplifier, an optical phase modulator, a photodetector, or the like. The first optical waveguide 10 and the fifth optical waveguide 50 are formed by processing the first stack 10a described above. The third optical waveguide 30 and the fourth optical waveguide 40 are formed by processing the third stack 30a described above.

### Variation 2

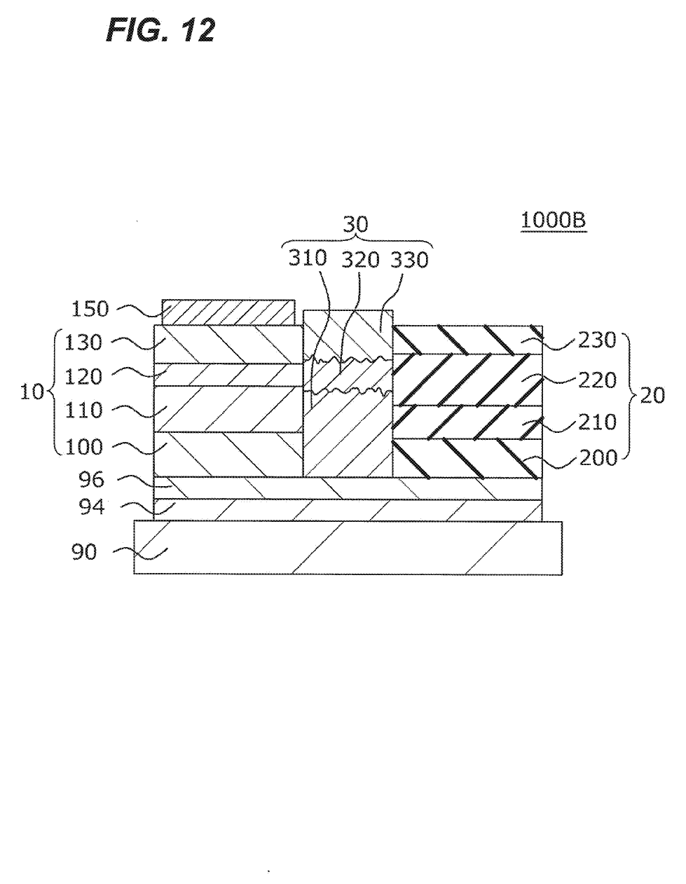

FIG. 12 is a cross-sectional view of an optical circuit 1000B of Variation 2. The cross-sectional direction is the same as that along line II-II in FIG. 1. The optical circuit 1000B of Variation 2 differs from the optical circuit 1000 of Embodiment 1 such that an adhesive layer 94 is disposed between the support substrate 90 and each optical waveguide.

The material for the adhesive layer 94 has only to be one that can bond the optical waveguides and the support substrate 90, for example, Au, Al₂O₃, epoxy resin-based adhesives, or silicon-based adhesives.

The adhesive layer 94 has about the same thickness between the support substrate 90 and the first optical waveguide 10, between the support substrate 90 and the second optical waveguide 20, and between the support substrate 90 and the third optical waveguide 30. This makes the end faces of individual optical waveguides less prone to tilting, making the optical coupling efficiency less apt to decrease. The thickness of the adhesive layer 94 may be, for example, 0.1 nm to 100 nm, preferably 1 nm to 10 nm.

The lower end face of each optical waveguide is preferably planarized before being bonded to the support substrate 90. The lower face of each optical waveguide may be planarized or provided with a planarization layer 96. The planarization layer 96 has only to be a material that is easily planarized and bondable to the adhesive layer 94, such as a metal, resin, or dielectric. This allows the adhesive layer 94 to have a relatively uniform thickness when bonding the support substrate 90 to each optical waveguide, making the optical coupling efficiency less apt to decrease in each optical waveguide.

### Variation 3

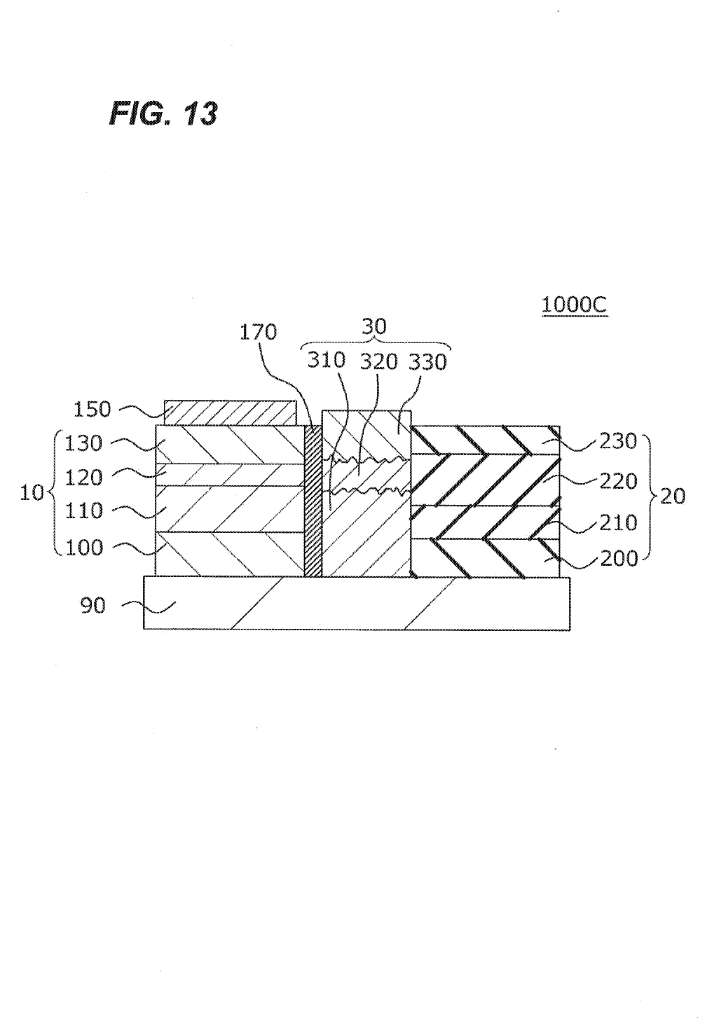

FIG. 13 is a cross-sectional view of an optical circuit 1000C of Variation 3. The cross-sectional direction is the same as that along line II-II in FIG. 1. The optical circuit 1000C of Variation 3 differs from the optical circuit 1000 of Embodiment 1 such that an antireflective coating 170 is applied at one end of the first optical waveguide 10, and the first optical waveguide 10 and the third optical waveguide 30 are butt-joined via the antireflective coating 170. This reduces reflection at the end face, reducing reflection between the first optical waveguide 10 and the third optical waveguide 30 and improving optical coupling efficiency. The reflectance of the antireflective coating 170 may be, for example, higher than 0% but 5% at most, preferably higher than 0% but 1% at most, more preferably higher than 0% but 0.1% at most. The end face of the first optical waveguide 10 located opposite the end face on which the antireflective coating 170 is applied may have a high reflective coating, partial reflective coating, or no coating.

The antireflective coating 170 is a dielectric multilayer film. The dielectric multilayer film is, for example, a multilayer film including at least two selected from the group consisting of SiO₂, Al₂O₃, Ta₂O₅, SiN, MgF₂, and CaF₂. In the case in which the periodic direction of the dielectric multilayer film and the optical axis of the first optical waveguide 10 are misaligned, the misalignment can be 20° at most, 10° at most, 5° at most, and 1 ° at most.

The antireflective coating 170 can be disposed on one end face of the first stack 10a in advance. For the optical circuit 1000C having an antireflective coating 170, a third stack 30a can be formed after disposing the first stack 10a and the second stack 20a with a gap therebetween such that the end face of the first stack provided with an antireflective coating 170 opposes one end of the second stack. The other processes can be the same as those in the manufacturing method described above.

### Embodiment 1

An optical circuit 2000A of Embodiment 2 differs from an optical circuit 1000 of Embodiment 1 such that the second optical waveguide 20 further includes a wavelength selecting structure. This can allow the circuit to output laser light of a predetermined wavelength.

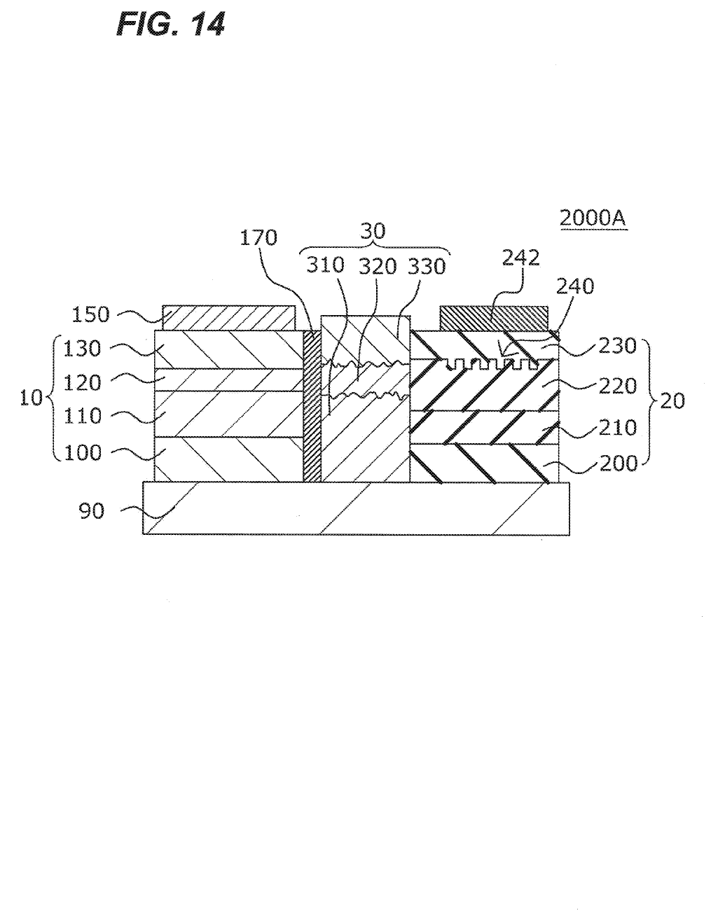

FIG. 14 is a cross-sectional view of an optical circuit 2000A of Embodiment 2. The cross-sectional direction is the same as that along line II-II in FIG. 1. The wavelength selecting structure is a structure that applies feedback to the first optical waveguide 10. For example, light having a predetermined wavelength in the light emitted by the first optical waveguide 10 is reflected by the wavelength selecting structure. The first optical waveguide 10 oscillates in response to the wavelength of light fed back. This can allow for a selection of oscillation wavelength.

In such a wavelength selection process, the light emitted by the first optical waveguide 10 passes through the third optical waveguide 30 two times or more. Thus, scattering losses tend to occur when the light passes through the third optical waveguide 30. Similar to Embodiment 1, because scattering losses in the third optical waveguide 30 in Embodiment 2 are reduced, it is possible to select a wavelength efficiently.

FIG. 14 shows an example in which the wavelength selecting structure is constituted by distributed Bragg reflector 240. The distributed Bragg reflector 240 is a periodic structure of materials having different refractive indices. As shown in FIG. 14, the distributed Bragg reflector 240 may be a periodic structure provided at the interface between the second core layer 220 and the second upper clad layer 230.

The period of the periodic structure, the distributed Bragg reflector 240, may be, for example, 50 nm to 300 nm, 70 nm to 250 nm, preferably 100 nm to 160 nm, more preferably 120 nm to 140 nm. The reflection bandwidth of the distributed Bragg reflector 240 may be, for example, 50 pm to 500 pm, preferably 80 pm to 120 pm. This can reduce the spectral linewidth of laser light.

The distributed Bragg reflector 240 is not limited to the form shown in FIG. 14, and can be formed by the second core layer 220 and the second lower clad layer 210, or formed on the upper face of the second upper clad layer 230. When a periodic structure is formed on the upper face of the second upper clad layer 230, periodic grooves are formed in the upper face of the second upper clad layer 230. The grooves are filled with air or a material having a different refractive index from that of the second upper clad layer 230. For the distributed Bragg reflector 240, the lateral face shape of the second optical waveguide 20 may be periodically changed, or a periodic structure may be formed at a position distanced from the second optical waveguide 20 by about a wavelength of light (e.g., periodically arranged pillars).

The optical circuit 2000A of Embodiment 2 may include a constituent of Variation 3. In other words, an antireflective coating 170 may be formed between the first optical waveguide 10 and the third optical waveguide 30. This can reduce reflection of light between the first optical waveguide 10 and the third optical waveguide 30, thereby improving the wavelength selection stability. The optical circuit 2000A of Embodiment 2, moreover, may include a heater 242 on the second upper clad layer 230 at which the distributed Bragg reflector 240 is provided. A desired wavelength can be selected by allowing the heater 242 to adjust the equivalent refractive index of the distributed Bragg reflector 240.

### Variation 4

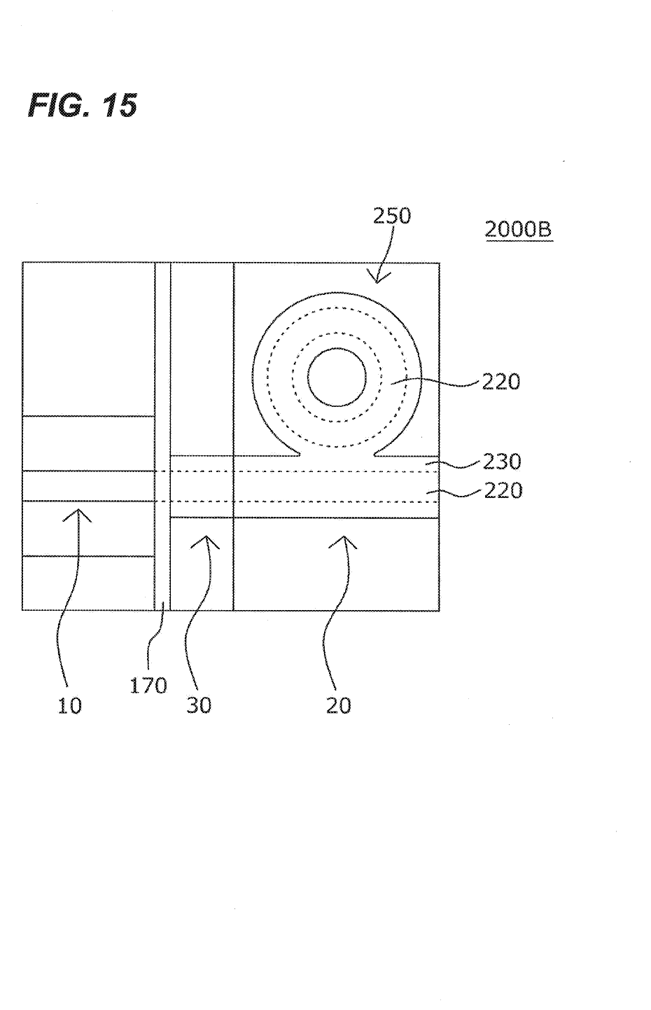

FIG. 15 is a top view of an optical circuit 2000B of Variation 4. FIG. 15 shows an example in which the wavelength selecting structure is configured with a ring resonator 250 optically coupled to the second optical waveguide. This allows the circuit to output laser light of a predetermined wavelength. The broken lines in FIG. 15 indicate the regions where the core layers of the second optical waveguide 20, the third optical waveguide 30, and the ring resonator 250 are formed.

The ring resonator 250, for example, is disposed on the second substrate 200 and has the same configuration as that of the second optical waveguide 20. In other words, the ring resonator 250 may have a second substrate 200, a second lower clad layer 210, a second upper clad layer 230, and a second core layer 220 disposed between the second lower clad layer 210 and the second upper clad layer 230. As shown in FIG. 15, the ring resonator 250 and the second optical waveguide have a common lateral clad layer. FIG. 15 shows an example in which the second upper clad layer 230 and the lateral clad layer are integrally formed, denoted by a common reference numeral. The second core layer 220 of the second optical waveguide 20 and the second core layer 220 of the ring resonator 250 are separated only by the distance that allows for optical coupling. In other words, the lateral clad layer of the second optical waveguide 20 is also the lateral clad layer of the ring resonator 250. This can simplify the configuration of the lateral clad layer and increase the coupling efficiency of the second optical waveguide 20 and the ring resonator 250.

The ring resonator 250 optically couples to the second optical waveguide 20 and transfers the light waveguided in the second optical waveguide 20 to the ring resonator 250. The wavelength of the light coupled to the ring resonator 250 is one that matches the optical path length around the ring when multiplied by an integer. In FIG. 15, the light coupled to the ring resonator 250 goes around counterclockwise. A portion of the light that goes around the ring resonator 250 is backscattered at the interface between the second core layer 220 and the second upper clad layer 230 of the ring resonator 250 and/or the interface between the second core layer 220 and the second lower clad layer 210 of the ring resonator 250, or the interface between the second core layer 220 and the lateral clad layer. The light that is backscattered and waveguided clockwise in the ring resonator 250 couples to the second optical waveguide 20, passes through the third optical waveguide 30, and returns to the first optical waveguide 10. The light returning to the first optical waveguide 10 has the wavelength selected by the ring resonator 250, i.e., feedback to the first optical waveguide 10. This allows the circuit to output laser light of a predetermined wavelength.

Similar to Embodiment 2, the optical circuit 2000Bof Variation 4 can reduce the impact of the scattering loss in the third optical waveguide 30, allowing for an efficient wavelength selection.

The ring resonator 250, similar to the second optical waveguide 20, is such that the bottom face of the ridge is positioned in the second lower clad layer 210. Accordingly, forming a ring resonator 250 in the second optical waveguide 20 can enhance lateral light confinement and reduce bending losses even when the optical waveguide is bent. Scattering losses in the ring resonator 250 are reduced because the arithmetic mean roughness Ra of the interface between the second core layer 220 and the second upper clad layer 230 and the arithmetic mean roughness Ra of the interface between the second core layer 220 and the second lower clad layer 210 can be made relatively small. This makes the ring resonator 250 an optical waveguide having a high Q factor, which can make laser light a narrow linewidth laser.

The equivalent refractive index of the ring resonator 250 may be adjusted by using a heater. Wavelength selection may be controlled by utilizing the temperature dependency of the equivalent refractive index of the ring resonator 250.

As explained with reference to Embodiment 2 and Variation 4, the wavelength selecting structure may be, for example, a distributed Bragg reflector 240 or a ring resonator 250. The wavelength selecting structure may be a grating that reflects light of a predetermined wavelength to be extracted from the optical circuit 2000A or 2000B while transmitting light of unselected wavelengths. The wavelength selecting structure has only to be a structure that can select a wavelength within the gain of the first optical waveguide 10. Specific structures are not limited to those described above.

### Embodiment 3

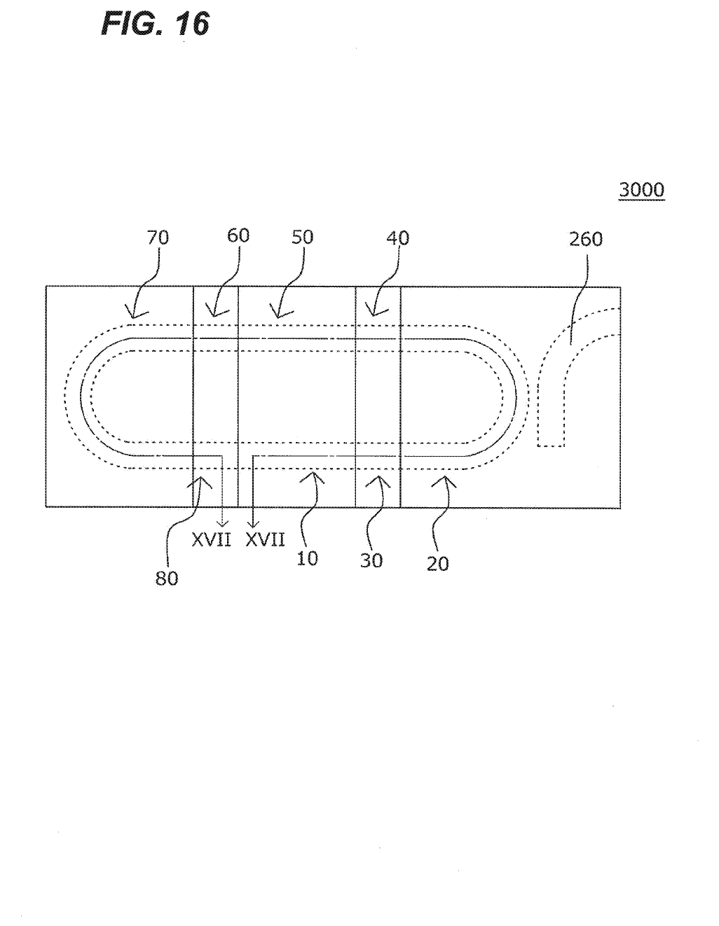

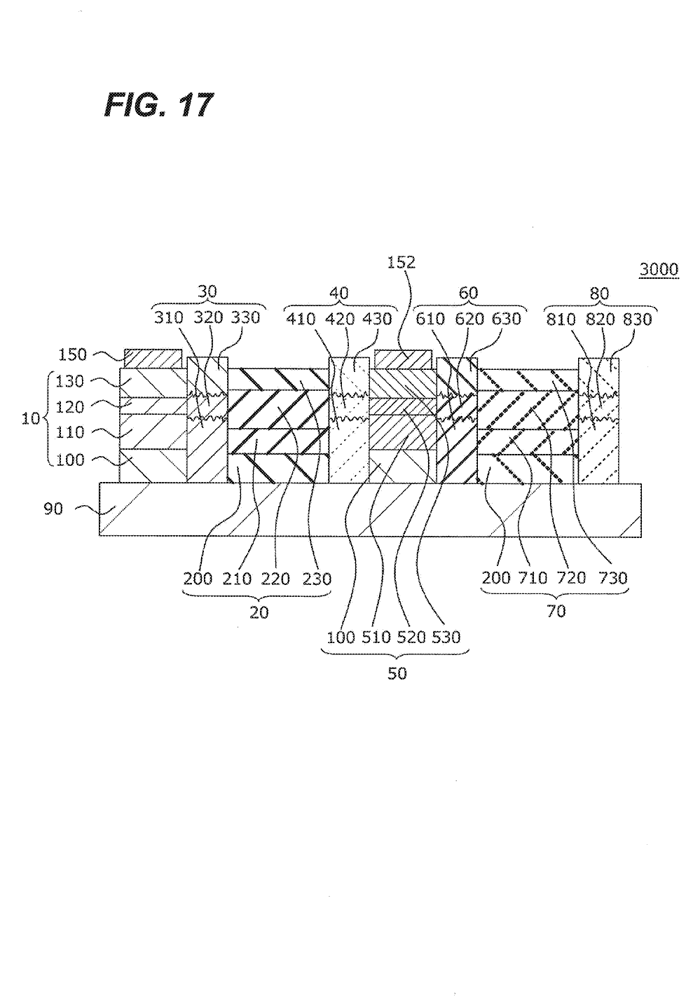

An optical circuit 3000 of Embodiment 3 will be described. The optical circuit 3000 of Embodiment 3 is a form in which the first optical waveguide 10, the second optical waveguide 20, and the third optical waveguide 30 explained with reference to Embodiment 1 make up portions of a ring laser. FIG. 16 is a top view of the optical circuit 3000 of Embodiment 3. For the purpose of simplifying the drawing, the range of the core layer of each optical waveguide is indicated by broken lines, and the lateral clad layer omitted. FIG. 17 is a cross-sectional view taken along line XVII-XVII in FIG. 16, showing a cross section along the optical axis of the ring laser.

The optical circuit 3000 of Embodiment 3 includes a ring laser that has, besides the first optical waveguide 10, the second optical waveguide 20, and the third optical waveguide 30 described with reference to Embodiment 1, a fourth optical waveguide 40, a fifth optical waveguide 50, a sixth optical waveguide 60, a seventh optical waveguide 70, and an eighth optical waveguide 80. In the ring laser, the first optical waveguide 10, the third optical waveguide 30, the second optical waveguide 20, the fourth optical waveguide 40, the fifth optical waveguide 50, the sixth optical waveguide 60, the seventh optical waveguide 70, and the eighth optical waveguide 80 are arranged along the optical axis of the ring laser.

As shown in FIG. 16, in a top view, the fifth optical waveguide 50 is positioned in the direction perpendicular to the optical axis of the first optical waveguide 10. The first optical waveguide 10 and the fifth optical waveguide 50 are straight waveguides. The first optical waveguide 10 is a semiconductor laser element or semiconductor laser amplifier, and the fifth optical waveguide 50 is a semiconductor laser element, semiconductor laser amplifier, or optical phase shift modulator. Accordingly, in the optical circuit 3000 of Embodiment 3, the first optical waveguide 10 is a first active waveguide, and the fifth optical waveguide 50 is a second active waveguide.

As shown in FIG. 17, the fifth optical waveguide 50 has a first substrate 100, a fifth lower clad layer 510, a fifth upper clad layer 530, and a fifth core layer 520 disposed between the fifth lower clad layer 510 and the fifth upper clad layer 530. The materials for the fifth optical waveguide 50 are selected from the group of materials that can be used for the first optical waveguide 10. In the case in which the fifth optical waveguide 50 is an optical phase shift modulator, the fifth core layer 520 may include, for example, a single layer of undoped GaN or Al_{b}Ga_{1-b}N(0<b≤1).

The second optical waveguide 20 and the seventh optical waveguide 70 include a bent waveguide. The seventh optical waveguide 70 is an optical wire. The seventh optical waveguide 70, similar to the second optical waveguide 20, is such that the lower end of the ridge is positioned in the seventh lower clad layer 710, and has strong lateral light confinement. This can reduce the ring laser’s bending loss.

As shown in FIG. 17, the seventh optical waveguide 70 has a third substrate, a seventh lower clad layer 710, a seventh upper clad layer 730, and a seventh core layer 720 disposed between the seventh lower clad layer 710 and the seventh upper clad layer 730. The materials for the seventh optical waveguide 70 are selected from the group of materials that can be used for the second optical waveguide 20.

As shown in FIG. 16, the fourth optical waveguide 40 connects the fifth optical waveguide 50 and the second optical waveguide 20. The sixth optical waveguide 60 connects the fifth optical waveguide 50 and the seventh optical waveguide 70. The eighth optical waveguide 80 connects the first optical waveguide 10 and the seventh optical waveguide 70. In a top view, the fourth optical waveguide 40 is positioned in the direction perpendicular to the optical axis of the third optical waveguide 30. The eighth optical waveguide 80 is positioned in the direction perpendicular to the sixth optical waveguide 60.

In the optical circuit 3000 of Embodiment 3, the fourth optical waveguide 40, the sixth optical waveguide 60, and the eighth optical waveguide 80 are amorphous waveguides. When the first optical waveguide 10 and the fifth optical waveguide 50 are butt-joined to the second optical waveguide 20 and the seventh optical waveguide 70, similar to Embodiment 1, the stacks that constitute these optical waveguides are disposed to oppose one another with a gap therebetween. The amorphous stacks are formed to fill these gaps. Processing the amorphous stacks by etching forms the amorphous waveguides, i.e., the fourth optical waveguide 40, the sixth optical waveguide 60, and the eighth optical waveguide 80.

As shown in FIG. 17, the fourth optical waveguide 40 has on the support substrate 90, a fourth lower clad layer 410, a fourth upper clad layer 430, and a fourth core layer 420 disposed between the fourth lower clad layer 410 and the fourth upper clad layer 430. The materials for the fourth optical waveguide 40 are selected from the group of materials that can be used for the third optical waveguide 30.

As shown in FIG. 17, the sixth optical waveguide 60 has on the support substrate 90, a sixth lower clad layer 610, a sixth upper clad layer 630, and a sixth core layer 620 disposed between the sixth lower clad layer 610 and the sixth upper clad layer 630. The materials for the sixth optical waveguide 60 are selected from the group of materials that can be used for the third optical waveguide 30.

As shown in FIG. 17, the eighth optical waveguide 80 has on the support substrate 90, an eighth lower clad layer 810, an eighth upper clad layer 830, and an eighth core layer 820 disposed between the eighth lower clad layer 810 and the eighth upper clad layer 830. The materials for the eighth optical waveguide 80 are selected from the group of materials that can be used for the third optical waveguide 30.

Similar to the third optical waveguide 30, the arithmetic mean roughness Ra of the interface between the fourth core layer 420 and the fourth upper clad layer 430 of the fourth optical waveguide 40 is larger than the arithmetic mean roughness Ra of the interface between the second core layer 220 and the second upper clad layer 230 of the second optical waveguide 20. The refractive index difference between the fourth core layer 420 and the fourth upper clad layer 430 of the fourth optical waveguide 40 is smaller than the refractive index difference between the second core layer 220 and the second upper clad layer 230 of the second optical waveguide 20. Accordingly, the scattering loss in the fourth optical waveguide 40 is reduced. The fourth core layer and the fourth lower clad layer 410 of the fourth optical waveguide 40 may have similar magnitude relations with respect to arithmetic mean roughness Ra and the refractive index difference. This can reduce the scattering loss in the fourth optical waveguide 40. The sixth optical waveguide 60 and the eighth optical waveguide 80 can be compared with the seventh optical waveguide 70 in terms of arithmetic mean roughness Ra and refractive index difference. If the sixth optical waveguide 60 is compared with the seventh optical waveguide 70, and the eighth optical waveguide 80 with the seventh optical waveguide 70, like how the second optical waveguide 20 is compared with the third optical waveguide 30, similar magnitude relations in terms of arithmetic mean roughness Ra and refractive index difference would result. This can reduce scattering losses in the sixth optical waveguide and the eighth optical waveguide.

Laser oscillation occurs in the ring laser as light goes around in the ring, passing the third optical waveguide 30, the fourth optical waveguide 40, the sixth optical waveguide 60, and the eighth optical waveguide 80 numerous times. A large loss would affect laser oscillation. However, losses in these optical waveguides are reduced in the optical circuit 3000 of Embodiment 3, and thus laser oscillation is facilitated.

The materials for the third optical waveguide 30 are preferably the same as those for the fourth optical waveguide 40. Using the same materials can simplify the manufacturing process. For the same reason, the materials for the sixth optical waveguide 60 are preferably the same as those for the eighth optical waveguide 80. More preferably, the third optical waveguide 30, the fourth optical waveguide 40, the sixth optical waveguide 60, and the eighth optical waveguide 80 are all formed of the same materials. This makes it easier to uniformly reduce Fresnel reflection occurring at the joints with the second optical waveguide and with the seventh optical waveguide.

As shown in FIG. 17, the fifth optical waveguide 50 has on the support substrate 90, a first substrate 100, a fifth lower clad layer 510, a fifth upper clad layer 530, and a fifth core layer 520 disposed between the fifth lower clad layer 510 and the fifth upper clad layer 530. When the fifth optical waveguide 50 works as a gain medium, the fifth core layer 520 may include a quantum well layer. The well layer may be, for example, In_{z}Ga_{1-z}N (0≤z≤1) or AlₐGa₁₋ₐN (0<a≤1). Adjusting the composition of the well layer allows the quantum well layer to emit light from red to ultraviolet light. Red light can be achieved by using AlGaInP mixed crystal. In the case in which the fifth optical waveguide 50 is an optical phase shift modulator, the fifth core layer 520 may include a single undoped GaN layer or Al_{b}Ga_{1-b}N (0<b≤1). An electrode 152 is disposed on the fifth upper clad layer 530.

The optical circuit 3000 of Embodiment 3 further has an output coupler 260 that extracts light from the ring laser. The output coupler 260 may have the same layering structure as that of the second optical waveguide 20. The output coupler 260 and the ring laser form a directional coupler and are optically coupled. The output coupler 260 outputs the laser light extracted from the ring laser to another optical waveguide having another optical function or the outside of the optical circuit 3000.

The constituent elements of the embodiments and variations explained thus far can be suitably combined.

### REFERENCE NUMERALS

10 first optical waveguide

100 first substrate

110 first lower clad layer

120 first core layer

130 first upper clad layer

140 insulation layer

150 first electrode

160 second electrode

170 antireflective coating

20 second optical waveguide

200 second substrate

210 second lower clad layer

220 second core layer

230 second upper clad layer

240 distributed Bragg reflector

242 heater

250 ring resonator

260 output coupler

30 third optical waveguide

310 third lower clad layer

320 third core layer

330 third upper clad layer

40 fourth optical waveguide

410 fourth lower clad later

420 fourth core layer

430 fourth upper clad layer

50 fifth optical waveguide

510 fifth lower clad layer

520 fifth core layer

530 fifth upper clad layer

60 sixth optical waveguide

610 sixth lower clad layer

620 sixth core layer

630 sixth upper clad layer

70 seventh optical waveguide

710 seventh lower clad layer

720 seventh core layer

730 seventh upper clad layer

80 eighth optical waveguide

810 eighth lower clad layer

820 eighth core layer

830 eighth upper clad layer

90 support substrate

92 provisional substrate

94 bonding layer

96 planarization layer

910 mask

920 mask

10a first stack

20a second stack

30a third stack

What is claimed is:

1. An optical circuit comprising:
a support substrate;
a first optical waveguide located on the support substrate and comprising:
a first substrate,
a first lower clad layer disposed on the first substrate,
a first upper clad layer, and
a first core layer interposed between the first lower clad layer and the first upper clad layer;
a second optical waveguide located on the support substrate and comprising:
a second substrate formed of a material different from a material for the first substrate,
a second lower clad layer,
a second upper clad layer, and
a second core interposed between the second lower clad layer and the second upper clad layer; and
a third optical waveguide located on the support substrate and comprising,
a third lower clad layer,
a third upper clad layer, and
a third core layer interposed between the third lower clad layer and the third upper clad layer; wherein
the first optical waveguide is an active waveguide configured to emit light with a wavelength shorter than a wavelength of infrared light,
the third optical waveguide is interposed between the first optical waveguide and the second optical waveguide,
the third optical waveguide is butt-joined to at least one of the first optical waveguide or the second optical waveguide,
the third optical waveguide is an amorphous waveguide, and
the third optical waveguide satisfies at least one of:
(i) an arithmetic mean roughness (Ra) of an interface between the third core layer and the third upper clad layer is larger than an arithmetic mean roughness (Ra) of an interface between the second core layer and the second upper clad layer, and a refractive index difference between the third core layer and the third upper clad layer is smaller than a refractive index difference between the second core layer and the second upper clad layer, or
(ii) an arithmetic mean roughness (Ra) of an interface between the third core layer and the third lower clad layer is larger than an arithmetic mean roughness (Ra) of an interface between the second core layer and the second lower clad layer, and a refractive index difference between the third core layer and the third lower clad layer is smaller than a refractive index difference between the second core layer and the second lower clad layer.

2. The optical circuit according to claim 1 wherein the second optical waveguide comprises a wavelength selecting structure.

3. The optical circuit according to claim 1 further comprising;
a ring laser, wherein:
the ring laser comprises the first optical waveguide, the third optical waveguide, the second optical waveguide, a fourth optical waveguide, a fifth optical waveguide, a sixth optical waveguide, a seventh optical waveguide, and an eighth optical waveguide disposed along an optical axis of the ring laser,
in a top view, the fifth optical waveguide is positioned in a direction perpendicular to an optical axis of the first optical waveguide,
the first optical waveguide is a first active waveguide,
the fifth optical waveguide is a second active waveguide,
the second optical waveguide and the seventh waveguide each comprises a bent waveguide, and
each of the fourth optical waveguide, the sixth optical waveguide, and the eighth optical waveguide is an amorphous waveguide.

4. The optical circuit according to claim 1, wherein:
the refractive index difference between the third core layer and the third upper clad layer is 1 or smaller, or
the refractive index difference between the third core layer and the third lower clad layer is 1 or smaller.

5. The optical circuit according to claim 1, wherein a thickness of the third core layer is larger than a thickness of the first core layer and smaller than a thickness of the second core layer.

6. The optical circuit according to claim 2, wherein a thickness of the third core layer is larger than a thickness of the first core layer and smaller than a thickness of the second core layer.

7. The optical circuit according to claim 3, wherein a thickness of the third core layer is larger than a thickness of the first core layer and smaller than a thickness of the second core layer.

8. The optical circuit according to claim 1, wherein a length of the third optical waveguide in an optical axis direction of the third optical waveguide is at least 0.01 times but less than 1 times a length of the second substrate in the optical axis direction of the third optical waveguide.

9. The optical circuit according to claim 2, wherein a length of the third optical waveguide in an optical axis direction of the third optical waveguide is at least 0.01 times but less than 1 times a length of the second substrate in the optical axis direction of the third optical waveguide.

10. The optical circuit according to claim 3, wherein a length of the third optical waveguide in an optical axis direction of the third optical waveguide is at least 0.01 times but less than 1 times a length of the second substrate in the optical axis direction of the third optical waveguide.

11. The optical circuit according to claim 1, wherein the third lower clad layer is disposed between the first substrate and the second substrate in an optical axis direction of the third optical waveguide.

1212 The optical circuit according to claim 2, wherein the third lower clad layer is disposed between the first substrate and the second substrate in an optical axis direction of the third optical waveguide.

13. The optical circuit according to claim 3, wherein the third lower clad layer is disposed between the first substrate and the second substrate in an optical axis direction of the third optical waveguide.

14. The optical circuit according to claim 8, wherein the third lower clad layer is disposed between the first substrate and the second substrate in an optical axis direction of the third optical waveguide.

15. The optical circuit according to claim 1, wherein at least one of:
(a) a material for the third core layer is different from a material for the second core layer in terms of material system or composition,
(b) a material for the third upper clad layer is different from a material for the second upper clad layer in terms of material system or composition, or
(c) a material for the third lower clad layer is different from a material for the second lower clad layer in terms of material system or composition.

16. The optical circuit according to claim 2, wherein at least one of:
(a) a material for the third core layer is different from a material for the second core layer in terms of material system or composition,
(b) a material for the third upper clad layer is different from a material for the second upper clad layer in terms of material system or composition, or
(c) a material for the third lower clad layer is different from a material for the second lower clad layer in terms of material system or composition.

17. The optical circuit according to claim 1, wherein:
the second optical waveguide includes an oxide or oxynitride, and
the third optical waveguide includes an oxide or oxynitride.

18. The optical circuit according to claim 1, wherein:
an antireflecting coating is applied to one end face of the first optical waveguide, and
the first optical waveguide and the third optical waveguide are butt-joined via the antireflective coating.

19. The optical circuit according to claim 11, wherein:
an antireflecting coating is applied to one end face of the first optical waveguide, and
the first optical waveguide and the third optical waveguide are butt-joined via the antireflective coating.

20. The optical circuit according to claim 1, wherein the second optical waveguide is an optical wire that includes a bent waveguide.
